(19) United States
(12) Patent Application Publication
(10) Pub. No.: US 2008/0098013 A1
(43) Pub. Date: Apr. 24, 2008

(54) DATA ACCESS AND COMMUNICATION SYSTEM

(76) Inventor: Stephen William Byng, Lane Cove NSW (AU)

Correspondence Address: MCANDREWS HELD & MALLOY, LTD, 500 WEST MADISON STREET, SUITE 3400, CHICAGO, IL, 60661, US

(21) Appl. No.: 11/957,116

(22) Filed: Dec. 14, 2007

Related U.S. Application Data
(63) Continuation of application No. 10/825,697, filed on Apr. 15, 2004.

(30) Foreign Application Priority Data
Apr. 15, 2003 (AU) 2003901806

(51) Int. Cl. G06F 7/00

(52) U.S. Cl. 707/100; 707/E17.046

(57) ABSTRACT

A method of providing access to data across one or more environments in a data system, the method comprising the steps of identifying and classifying data as non-critical data or critical data, and classifying critical data as authoritative data in situations where the data requires immediate access in order to provide a seamless interface to a user, the authoritative data being the most recent value of a data entry.

### RELATED APPLICATIONS

This application claims priority to and benefit as a continuation of U.S. patent application Ser. No. 10/825,697, filed on Apr. 15, 2004, entitled “Data Access and Communication System,” which claims priority benefits of Australian Provisional Application No. 2003901806, filed on Apr. 15, 2003, entitled “Data Access and Communication System,” both of which are herein incorporated by reference in their entirety.

### PRIORITY INFORMATION

This application claims priority benefits of Australian Provisional Application No. 2003901806 filed Apr. 15, 2003 entitled, “Data Access and Communication System,” the content of which is incorporated herein by reference.

### FIELD OF THE INVENTION

This invention relates to a method and system of providing access to data across one or more environments. It also relates to a method and system of communicating between a source component and a destination component across one or more environments and to a method of writing data to a data storage module. It has particular application in the gaming industry.

### BACKGROUND TO THE INVENTION

There is a need to adapt a product, particularly in the gaming industry, to meet a customer's needs by customising a solution within the limitations of a customer's circumstances. For example, this may include the necessity to (a) adapt to a customer's requirements with regard to the size of a client in a client server architecture, for example thin to thick client and (b) adapt to allow a range of product size and cost, that is minimum architecture to fully featured architecture. The former allows the product to suit the customer's needs due to limitations enforced by circumstances such as jurisdictional regulations or player preferences. An example would be the circumstances where a jurisdictional authority mandates that all player terminals must keep a record of their own transactions. This would restrict the application of a thin client architecture. The latter allows the customer to trade off a functionality or power for a reduction in cost. An example may be that the graphics capability is reduced with the cost of saving associated with a cheaper graphics card.

At present, the most popular product within the gaming industry is a stand alone machine, which creates and modifies all of the data associated with its operation and stores that information internally for retrieval as necessary. N-tier applications have become the norm for building enterprise software today. An N-tier application can be anything that is divided into discrete logical parts, the most common choice being a three part breakdown into a presentation layer, a business logic layer and a data layer. FIG. 1 shows an illustration of an N-tier architecture.

The self contained stand alone machine may be thought of as a client only or extremely thick client architecture. At the other extreme, it is possible to require an extremely thin client architecture as is the case if it is desirable to reduce the cost of the many necessary client terminals. In order to make a particular product completely adaptable to the customer's requirement, it is therefore necessary to provide the ability to adapt between these two extremes. The gaming industry in particular poses unique challenges to the use of N-tier architecture such as the essential storage of critical data and the recovery from events that disrupt the system, while still presenting a smooth interface to the user.

Software, in applications for the gaming industry, is focussed on the access and manipulation of data. This data is often categorised as critical information or non-critical data. This includes the data associated with the state and event information storage, multimedia images and various messages. The data stored within the gaming system may be thought of as falling into two broad categories, being critical data and non-critical data. Critical data is that which is considered vital to the continued operation of the gaming machine, for example meters and game outcomes. The primary requirement regarding critical data is concerned with the integrity of the data. If data has inappropriately been modified since its creation, then this will require the ability to identify errors and act accordingly. The identification of errors should occur before any critical service accesses the critical memory. It is imperative that incorrect data be corrected immediately. On the other hand, non-critical data is all the data that is not considered vital to the continued operation of the gaming machine, for example, all graphic and audio images. The primary requirement regarding this type of data concerns the integrity of the data at the time the Player Terminal is powered.

Within a system that uses an N-tier model with a database as the data storage facility, the server will need to maintain a dynamic representation of the data for each user. Delays that would be created by updating the database every time any parameter for a player changes would cripple the server and substantially use all its resources and time. The time it would take to do a synchronous update for a batch of entities could become prohibitively long and such time cannot be afforded for database updates to take place.

The other primary problem with adapting software to varying degrees of a distributed system, such as a client server system, is the changing requirements of internal component communication. Components or functionality may change location and a certain component may be required to exist within the presentation tier, for example, and hence reside on the client terminal. In other configurations it may be required to operate within the business logic layer and hence is located on the server side. An example would be the component that determines the outcome of a game. This may either exist within the business logic (server) or it may exist within the presentation layer (client). The outcome of a game must then be displayed to the player. Hence, this component communicates to the component that displays outcomes to the player which will almost always reside within the presentation layer. These two components will reside in the same environment in some circumstances and in different environments at other times. Thus, the present invention seeks to enable a communication system between components of a data system whether they are in the same environment or different environments.

Furthermore, the present invention seeks to provide a solution that allows a product the ability to adapt between a client only solution and a thin client solution by addressing the problems of storage of critical data, recovering from events that disrupt the system, providing a seamless interface to the user and providing seamless component communication.

### SUMMARY OF THE INVENTION

According to a first aspect of the invention there is provided a method of providing access to data across one or more environments in a data system, said method comprising the steps of:

identifying and classifying data as non-critical data or critical data; and

classifying critical data as authoritative data in situations where the data requires immediate access in order to provide a seamless interface to a user, the authoritative data being the most recent value of a data entry.

Preferably the method further includes the step of storing the authoritative data in an authoritative data store and the further step of displaying the authoritative data to the user after the authoritative data has been stored. The method may further include the step of adjusting the classification of data entries stored as the particular environment changes. The method may further comprise the step of storing the classification of the data in a file means and thereafter storing the data in a designated location in a data storage module according to how the data entry is classified.

Thus, by identifying and classifying the data as critical or non-critical and then further classifying critical data as authoritative data and more particularly reclassifying the data as it moves across one or more different environments, such as a presentation layer or a business layer, this provides the user with the flexibility to use different sized architectures in their system, for example a thin client or thick client. Thus within an N-tier model that uses a business layer and a presentation layer, a server within that system can maintain a dynamic representation of each of the data entries for the various users of the system.

According to a second aspect of the invention there is provided a method of writing data to a data storage module, said method comprising the steps of:

classifying a newly created data entity as critical data or non-critical data;

obtaining a current value of the data entity;

determining the location at which the current value is to be stored in the data storage module on the basis of the classifying step; and

storing the current value in the determined location.

Preferably the method further comprises the step of where the current value is not critical data, storing the current value in volatile storage of the data storage module. Preferably the method further comprises the step of where the current value is authoritative data, storing the current value in an authoritative source of the data storage module. Preferably the method further comprises the step of where the current value is not authoritative data, storing the current value in non-volatile storage of the data storage module.

According to a third aspect of the invention there is provided a method of communicating between a source component and a destination component of a data system across one or more environments, said method comprising the steps of:

identifying the relative location of the source component and the destination component;

determining if the source component and destination component are within the same environment or separate environments; and

establishing communication between the source component and destination component on the basis of the determining step.

Preferably where the source component and destination component share the same environment, the method further comprises the step of determining whether the source component and destination component are within the same process. If they are in the same process then preferably the communications mechanism established between the source component and destination component is an intra-process communication. If the source component and destination component are in different processes but within the same environment, preferably the communication mechanism established between the source component and destination component is an inter-process communication. Where the source component and destination component are in different environments, preferably a distributed communication mechanism or a network protocol is used for communicating between the source component and destination component.

### BRIEF DESCRIPTION OF THE DRAWINGS

The preferred embodiments of the invention will hereinafter be described, by way of example only, with reference to the accompanying drawings wherein:

FIG. 1 is a schematic diagram of an N-tier architecture;

FIG. 2 is a schematic diagram of an asynchronous database update;

FIG. 3 is a schematic diagram showing data storage within the various tiers of an N-tier system;

FIG. 4 is a flow chart showing the general flow identifying storage requirements of data;

FIG. 5 is a flow chart showing the general flow of a data storage write operation;

FIG. 6 is a flow chart detailing the process establishing an appropriate communication mechanism between components of a data system; and

FIG. 7 is a schematic diagram showing various components within processes and environments and the communication procedure between one component and other components within the system.

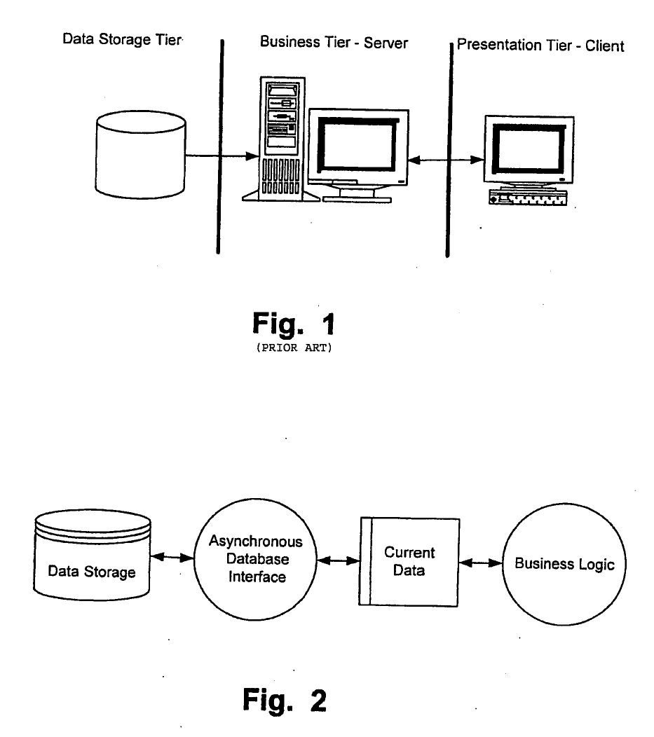

### DETAILED DESCRIPTION OF THE PREFERRED EMBODIMENTS

The present invention is particularly suitable or applicable to the gaming industry and provides a solution to adapt the needs of a customer. The invention particularly involves the creation of a data storage module that includes hardware and software that can be used in any one of the tiers mentioned previously. It also discloses a component communication mechanism that adapts to varying locations of components across environments and processes.

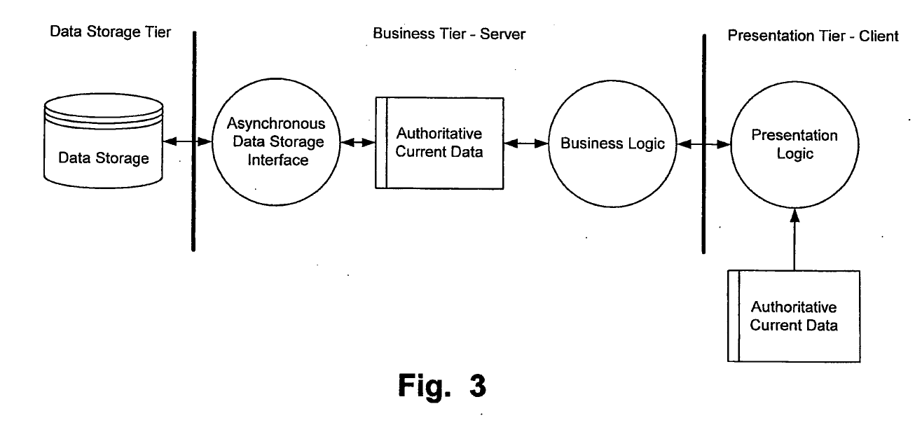

A particular solution to the problem of a server maintaining dynamic representation of data for each user in an N-tier model system, with a database as the data storage facility, is to make all database updates entirely asynchronous. This essentially means that there are two representations of the same information on the system. It is then necessary to determine which information is the most accurate or authoritative. The data depicted, as current data in FIG. 2 which shows an asynchronous database update, is more recent and thus should not be overwritten. In circumstances where the current data has been identified as corrupt, then it is necessary to restore the system to its last known correct state. Thus there is a necessity for a mechanism to identify and, if feasible, correct errors. Part of this mechanism may be to override the current data with a valid value from the database. The data depicted in FIG. 2 as current data is authoritative and there is the possibility for other areas of the system to require authoritative storage or an authoritative source such as disclosed in FIG. 3.

Data management has two fundamental operations, read and write. It is essential that these operations are performed as accurately and efficiently as the circumstances dictate. Data within a data system must be analysed according to the requirements of the system to determine how that data should be stored. Further to the consideration of and definitions of critical data and non-critical data, it is necessary to access data relatively quickly so that the system maintains a seamless interface to the user. Thus, data can have extra requirements beyond that of being critical. The critical data that requires relatively quick access time is known as authoritative data. This, like critical data, needs to be accurate implying a mechanism to identify and, if possible, correct errors. An authoritative source requires a solution to provide a non-volatile data storage medium to store data, software to provide read and write operations to manage authoritative data, sufficiently fast access to ensure a seamless interface, a process to automatically adjust the data entry stored as the environment changes or in moving to a different environment and data integrity software. The first three requirements are physical requirements and may be implemented in a variety of methods which includes the use of battery backed RAM. The requirement of data integrity software may be implemented through a variety of error detection and correction techniques.

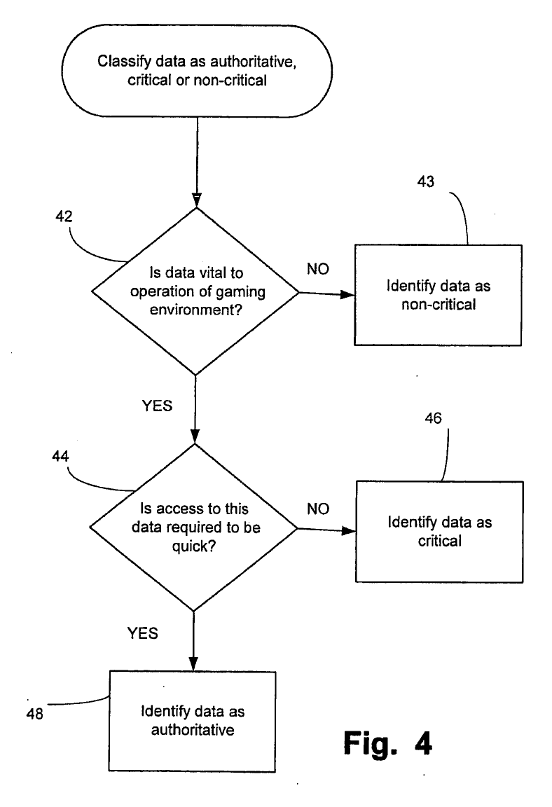

In FIG. 4 there is shown a general process flow identifying storage requirements of the data. Each data entity is examined based on its relative importance to the guaranteed services of the system. At step 42, a decision is made as to whether the data is vital to the operation of the gaming environment. If it is not, then the process goes to step 43 where it is identified as being non-critical data. If the data is considered vital to such operation then at step 44 a further query is ascertained as to whether access to this data is required to be quick or immediate. The term “quick” is subjective and depends on the access delays in the data system. If not then it is identified as critical data at step 46 or at step 48 if access is required immediately the data is identified as being authoritative. Thus if the data is essential and needs to be readily accessible then it is considered to be authoritative data. If the access time provided by the system results in invisible discontinuity of service to a user, then the data entity requires authoritative data storage. It is quite feasible in some circumstances or environments that all critical data requires authoritative storage.

The analysis and classification of the data storage requirements into non-critical, critical and authoritative may be implemented as a human activity to facilitate manual configuration of the system or within the software itself to facilitate dynamic relocation. Implementation within software could store the classification of the data to a file and this file can then be read, during system initialisation or even in real time when storing data. The information may then be used to store the data in the appropriate location. Information contained in the file may be an explicit example of a distinct classification of critical data or authoritative data. Data that is essential to the operation of the system is considered critical data. If the data is accessed during initialisation, it is unlikely to be time dependent and hence remains only critical data. However, in situations where the data is accessed just prior to storing data, then access needs to be efficient and hence it will be an example of authoritative data. Essential information about individual data entries that must be identified and stored include manner of creation, frequency of creation, identity of the component that creates the data and accessibility requirements.

The existence of an authoritative source also defines an additional criterion on the storage of data that is to be displayed. Authoritative data by definition is the most recent value of that data entry and thus data that is destined to be displayed must be stored first, and then displayed. This also implies that if data is created but destroyed due to some anomaly before it is stored, then it should be regarded as never having been created unless its creation is completely recoverable.

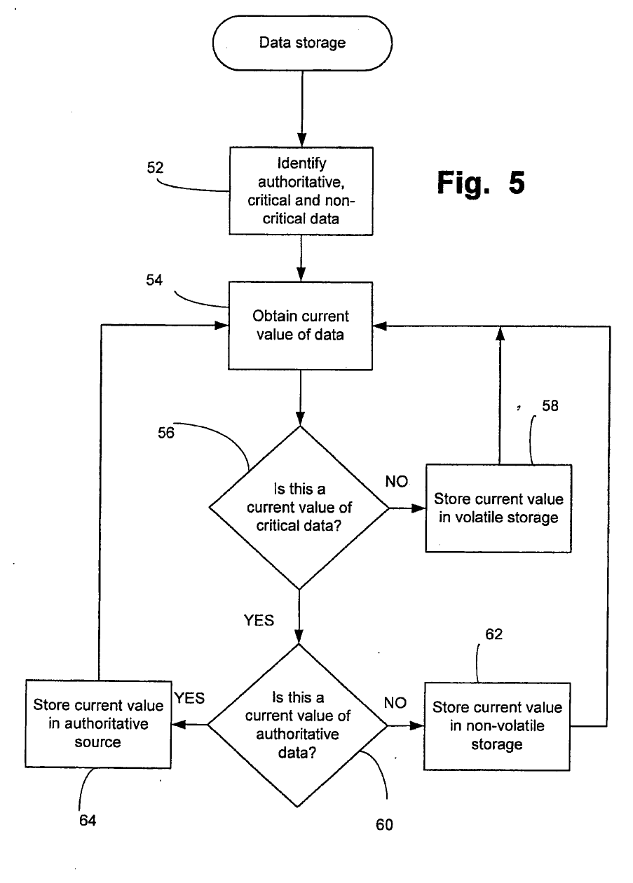

Shown in FIG. 5 is a general flow of the data storage write operation. The data at step 52 is identified as either being authoritative, critical or non-critical data. The information that is stored in the system is used as data needs to be stored. Thus as a new value for a data entity is created, it is examined to determine where it should be stored. The classification at step 52 of the data is in accordance with the process outlined with respect to FIG. 4. This information is then used to direct the storage of data to its appropriate location. At step 54 a current value of the data is obtained. Then at step 56 a determination is made as to whether this current value is a current value of critical data. If the current value is not critical data, then at step 58 the current value is stored in a volatile storage module and the process moves back to step 54 to obtain a further current value of data. If the current value is critical data at step 56 then the process moves to step 60 to determine whether or not the current value is that of authoritative data. If it is not a current value of authoritative data then at step 62 the current value is stored in a non-volatile storage module and the process moves back to step 54. If the current value is of authoritative data then it is stored in an authoritative source or storage module at step 64 and the process moves or returns to step 54.

A specific implementation of authoritative storage could include a data file that is manually coded to provide the general or logical rules. These rules might include that data displayed to the player generated on the server requires authoritative storage. Auditing meters and previous game history is considered critical while all other data is non-critical. At initialisation data elements are examined and classified, and subsequently addresses are created to indicate their location within the appropriate memory segment or sector. In this example if some of the data displayed to the player were moved from the server to the client, it would then no longer be classified as requiring authoritative storage.

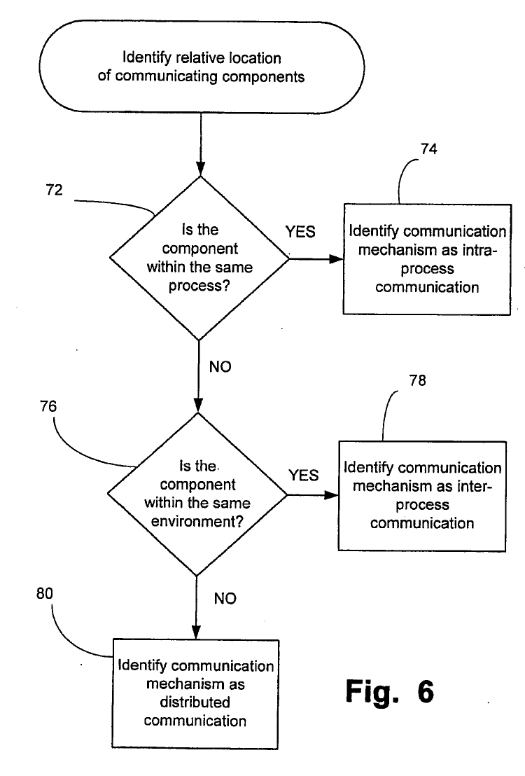

With reference to FIG. 6 there is shown a flow chart detailing the process establishing the appropriate communication mechanism between communicating components of the system. As a component needs to send a command or some information to another component it must first be determined where the component is within the system and then establish the appropriate communication mechanism. Components within the same process that share the same address space may communicate through function calls or thread communication. Components using the same operating system but possessing their own address space (stack) would communicate through inter-process of communication. Components that reside on different operating systems or physically different machines would communicate via a network protocol. Thus in FIG. 6 at step 72 a determination is made as to whether those components are within the same process. If they are within the same process then at step 74 a communication mechanism is identified as being intra-process communication. If the source component is not within the same process as the component (destination) it wishes to communicate with, then at step 76 a determination is made as to whether the source component is within the same environment as the destination component. If it is then at step 78 the communication mechanism is identified as being inter-process communication. If not then at step 80 the communication mechanism is identified as being distributed communication.

It is feasible that the intra-process components may be further categorised as intra-thread and inter-thread and network communication as local area network communication and wide area network communication.

During initialisation, the system could have each component identify its location within the system and store this information to be used by other components when transmitting and receiving information or commands. Essential information about individual components that must be identified and stored include the location within the system, services provided by the component, outputs of the component, communication mechanisms and inputs of the component.

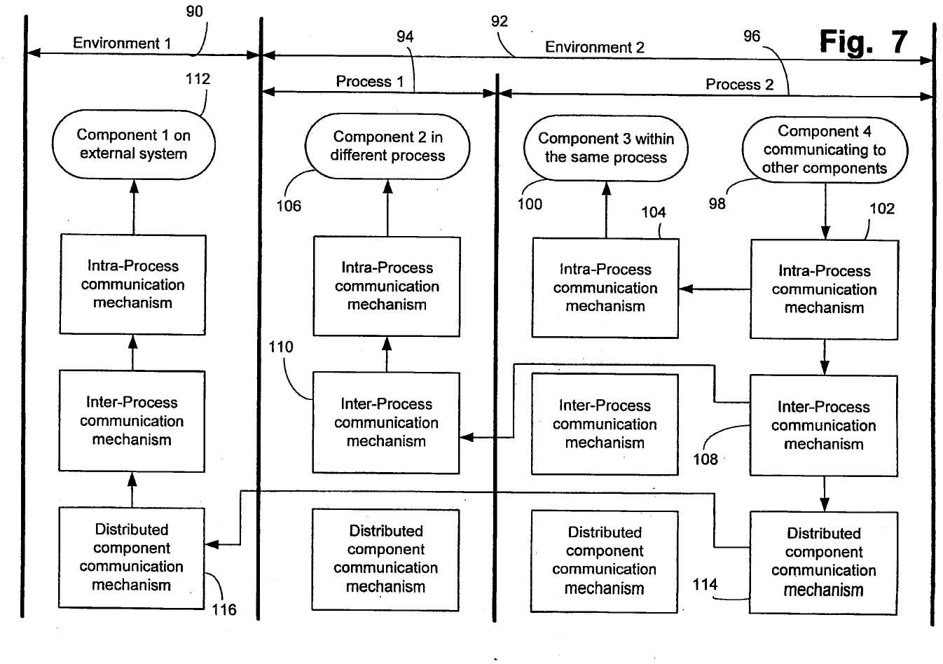

In FIG. 7 there is shown details as to how one component uses a different communication mechanism, depending on the location of the component with which it wishes to communicate. Two environments 90 and 92 are shown and within environment 92 are two processes 94 and 96. A transmitting (source) component 98 that resides in the process 96 of environment 92 may need to communicate with another component, for example destination component 100. With component 98 having determined that component 100 resides within the same process 96 as itself, it uses the intra-process communication mechanisms 102 and 104. Alternatively, if the source component 98 wishes to communicate with destination component 106 in process 94, having determined that component 106 is within the same environment 92 but in a different process, it may use an inter-process communication mechanism via components 108 and 110. If the source component 98 in process 96 needs to communicate with destination component 112 within environment 90, having determined that component 112 is in a different physical location it uses the distributed communication mechanism 114 and 116 in order to communicate with component 112.

When the components are within the one machine then the communication mechanism between these two components could be performed using the local function calls. When the components reside in two different machines, then network communication is necessary for these two components to communicate. Thus the communication mechanism between these two components changes from local function calls to inter-process communications. Any method of communicating between shifting components needs to change appropriately as the circumstances change. The communication mechanism may be regarded as either needing (1) local communication where both components reside in the same environment or (2) non-local communication where components reside in different environments.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of providing access to data across one or more environments in a data system, said method comprising the steps of:
identifying and classifying data in the data system as non-critical data or critical data; and
classifying critical data as authoritative data in situations where the data requires immediate access in order to provide a seamless interface to a user, the authoritative data being the most recent value of a data entry;
storing classified data in a particular data storage module so as to be accessible by one or more devices in the data system: and
adjusting the classification of the data in accordance with at least one of a change in a current environment of the data storage module and a move of the data from the data storage module to another environment;
wherein at least one of the data storage module in which the classified data is stored and the operation of the data system when handling the classified data is dependent on the classification of the data.

2. A method according to claim 1 further comprising the steps of storing the authoritative data in an authoritative data storage module and subsequently displaying the authoritative data to the user.

3. A method according to claim 2 further comprising the steps of storing the classification of the data in a file means and thereafter storing the data in a designated location in accordance with the classification of the data.

4. A method of writing data to a data storage module in an N-tier architecture, said method comprising:
classifying a newly created data entity as critical data or non-critical data;
obtaining a current value of the data entity;
determining the location within the N-tier architecture at which the current value is to be stored on the basis of the classifying step; and
storing the current value in a data storage module at the determined location; and
adjusting the classification of the data in accordance with at least one of a change in a current environment of the data storage module and a move of the data from the data storage module to another data storage module within the N-tier architecture.

5. A method according to claim 4 further comprising the step of storing the current value of the data entity in volatile storage of the data storage module where the current value of the data entity is not critical data.

6. A method according to claim 4 further comprising the step of storing the current value of the data entity in an authoritative source of the data storage module where the current value of the data entity is authoritative data.

7. A method according to claim 4 further comprising the step of storing the current value of the data entity in non-volatile storage of the data storage module where the current value of the data entity is not authoritative data.

8. Computer program means for directing a processing means to execute a procedure to enable access to data across one or more environments in a data system according to the method of claim 1.

9. Computer program means for directing a processing means to execute a procedure to write data to a data storage module according to the method of claim 4.

10. A method of writing data to a data storage module in a N-tier architecture, the method comprising:
classifying a newly created data entity as critical data;
identifying the location in the N-tier architecture where a said newly created data entity that has been classified as critical is to be stored;
classifying critical data as authoritative data in situations where the data requires immediate access in order to provide a seamless interface to a user, the authoritative data being the most recent value of a data entry, wherein the classification of critical data as authoritative data is dependent on the identified location:
obtaining a current value of the data entity; and
storing the current value in the identified location;
wherein at least one of the particular data storage module at the identified location in which the critical data is stored and the operation of the data system when handling critical data is dependent on whether that data is classified as authoritative data.

11. The method of claim 10, further comprising determining when critical data is communicated from one location to another location in the N-tier architecture and in response reclassifying the data.

12. A method of managing data storage within a data system having an N-tier architecture, the method comprising maintaining in memory a definition of a plurality of classifications of data, in a classification process performed in the data system comparing data in the data system to said definition to determine the classification of the data, and storing data in a particular tier within the data system dependent on the determined classification.

13. The method of claim 12, comprising classifying the data upon initialization of the N-tier application.

14. The method of claim 12, comprising classifying the data immediately preceding storage of the data.

15. The method of claim 12, wherein the plurality of classifications include critical data, which is data vital to the operation of the N-tier application, and noncritical data.

16. The method of claim 15, wherein the plurality of classifications include authoritative data, which is critical data requiring a short access time.

17. A method of storing data in a data system comprising storing information relating to a plurality of types of data in the data system, including at least information on the manner of creation of the data, frequency of creation of the data, identity of the component that creates the data and accessibility requirements for the data, accessing the stored information in an automatic data classification process run in the data system, and storing data classified in the automatic data classification process in a particular data storage module in the data system dependent on the classification of the data.

18. The method of claim 17, wherein the data system is a gaming system comprising an N-tier architecture and wherein the process of storing data classified in the automatic classification process comprises storing different classes of data in different data storage modules located in different tiers in the N-tier architecture.

19. The method of claim 18, wherein the classifications include a classification of data that is vital to the continued operation of the gaming system and which requires relatively quick access for display on a display in the gaming system and wherein the method comprises storing data within this classification before displaying images representing the data on the display.
